(19) United States
(12) Patent Application Publication
(10) Pub. No.: US 2013/0057232 A1
(43) Pub. Date: Mar. 7, 2013

(54) METHOD FOR REDUCING CURRENT THROUGH A LOAD AND AN ELECTRICAL DEVICE

(71) Applicants: Chieh-Ping CHIU, Erlun Township (TW); Mao-Kai WENG, Kuei Shan Hsiang (TW); Hsiao-Wei WU, Zhongli City (TW)

(72) Inventors: Chieh-Ping CHIU, Erlun Township (TW); Mao-Kai WENG, Kuei Shan Hsiang (TW); Hsiao-Wei WU, Zhongli City (TW)

(21) Appl. No.: 13/451,782

(22) Filed: Apr. 20, 2012

(30) Foreign Application Priority Data
Sep. 2, 2011 (TW) 100131710

(51) Int. Cl. G05F 1/12

(52) U.S. Cl. 323/220

(57) ABSTRACT

A method for reducing current flowing through a load within a particular frequency band includes the steps of configuring an electrical device to receive an alternating current (AC) signal; and configuring a filter to determine the current flowing through a load according to a frequency of the AC signal. An impedance of the filter in a conducting frequency band is lower than an impedance of the filter in a non-conducting frequency band so the filter divides the current of the AC signal within the conducting frequency band so that the load current through the load is reduced.

### CROSS-REFERENCE TO RELATED APPLICATION

The application claims priority to Taiwanese Application No. 100131710, filed on Sep. 2, 2011.

### BACKGROUND OF THE INVENTION

1. Field of the Invention

The invention relates to a method for reducing current through a load, more specifically, a method for reducing current flowing through a load when a signal frequency is within a particular bandwidth.

2. Description of the Related Art

As there is a possibility of harm when the human body is under long-term exposure to electromagnetic waves, the Federal Communications Commission (FCC) of the United States of America has set a limit of specific absorption rate (SAR) for hand-held wireless devices. In conventional designs of antennas, when the SAR exceeds the inspection limit, two following methods are usually used to reduce the current through the antennas to reduce the SAR. The first is by reducing the power of operation and the second is by arranging a component having an impedance value parallel to the current path. However, reducing the power of operation may cause rejections in other limitations of an antenna or radio frequency circuit. Arranging another component having an impedance value parallel to the current path may reduce the current flowing through the current path for all bandwidths with no specificity. Therefore, the invention looks into how to reduce current flowing through a load within a particular bandwidth.

### SUMMARY OF THE INVENTION

Therefore, the object of the present invention is to provide a method for reducing current flowing through a load when a signal frequency is within a particular bandwidth.

According to one aspect of the present invention, there is provided a method for reducing current flowing through a load within a particular frequency band. The method comprises steps of:

(a) configuring an electrical device to receive an alternating current (AC) signal; and

(b) configuring a filter to determine the current flowing through a load according to a frequency of the AC signal.

An impedance of the filter in a conducting frequency band is lower than an impedance of the filter in a non-conducting frequency band. In step (b), the filter divides the current of the AC signal within the conducting frequency band so that the current through the load is reduced.

Preferably, in step (b), a transmission line of the electrical device electrically coupled between the load and the filter moves a phase of the load to a high impedance region of a Smith Chart to further reduce the current through the load. A length of the transmission line is relative to the impedance region of the Smith Chart within which the phase of the load falls.

Preferably, in step (b), the filter is an acoustic wave filter.

Preferably, in step (b), the load is an antenna.

Another object of the present invention is to provide an electrical device to reduce current flowing through a load within a particular frequency band.

According to another aspect of the present invention, there is provided an electrical device for receiving an AC signal that comprises a load and a filter connected in parallel to the load. The filter determines a current flowing through the load according to a frequency of the AC signal.

An impedance of the filter in a conducting frequency band is lower than an impedance of the filter in a non-conducting frequency band. The filter divides the current of the AC signal within the conducting frequency band so that the current through the load is reduced.

Preferably, the electrical device further comprises a transmission line electrically coupled between the load and the filter. The transmission line moves a phase of the load to a high impedance region of a Smith Chart to further reduce the current through the load. Wherein a length of the transmission line is relative to the impedance region of the Smith Chart within which the phase of the load falls.

Preferably, the filter is a surface acoustic wave filter.

Preferably, the load is an antenna.

The advantage of the present invention lies in the parallel arrangement of the filter and the load that allows the division of current of the AC signal when the AC signal falls within a frequency band in which the filter has a lower impedance to the filter such that the current flowing through the load is reduced. The characteristics of the filter thus determine the particular frequency band in which the current flowing through the load can be reduced.

### BRIEF DESCRIPTION OF THE DRAWINGS

Other features and advantages of the present invention will become apparent in the following detailed description of the preferred embodiment with reference to the accompanying drawings, of which:

FIG. 1 is a circuit block diagram of the preferred embodiment of an electrical device implementing a reducing current flowing through a load according to the present invention;

FIG. 2 is a flow chart of the preferred embodiment of the method for reducing current flowing through a load;

FIG. 3 is a voltage standing wave ratio (VSWR) diagram of a filter of the preferred embodiment;

FIG. 4 is a Smith chart of the filter of the preferred embodiment;

FIG. 5 is a VSWR diagram of a load of the preferred embodiment when the length of a transmission line connecting the load and the filter is 10.5 mm;

FIG. 6 is a Smith chart of the load of the preferred embodiment when the length of the transmission line is 10.5 mm;

FIG. 7 is a VSWR diagram of a load of a control example when the length of a transmission line between the load and the input node is 10.5 mm;

FIG. 8 is a Smith chart of the load of the control example when the of the transmission line is 10.5 mm;

FIG. 9 shows the different impedance region of a Smith chart;

FIG. 10 is a VSWR diagram of the load of the control example when the length of the transmission line is 16.5 mm;

FIG. 11 is a Smith chart of the load of the control example with the of the transmission line is 16.5 mm;

FIG. 12 is a VSWR diagram of the load of the preferred embodiment with the length of the transmission line at 16.5 mm; and

FIG. 13 is a Smith chart of the load of the preferred embodiment when the length of the transmission line is 16.5 mm.

### DETAILED DESCRIPTION OF THE PREFERRED EMBODIMENTS

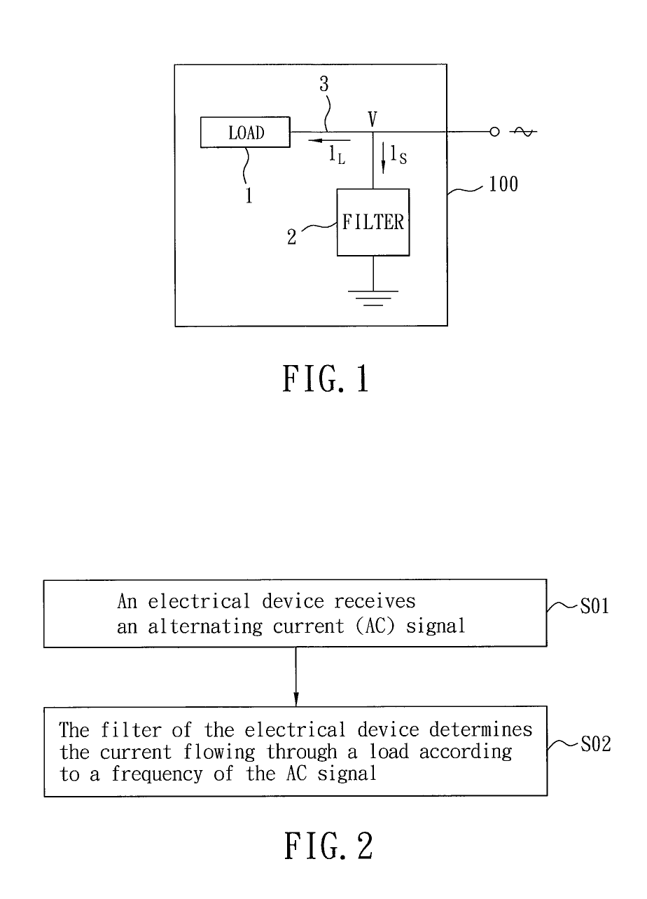

FIG. 1 shows an electrical device 100 implementing the method for reducing current flowing through a load according to the preferred embodiment of the present invention as illustrated in FIG. 2. The electrical device 100 includes a load 1 and a filter 2 connected in parallel to the load 1. In step S01, the electrical device 100 receives an alternating current (AC) signal at a junction between the load 1 and the filter 2. In step S02, the filter 2 of the electrical device 100 determines the current flowing through a load 1 according to a frequency of the AC signal.

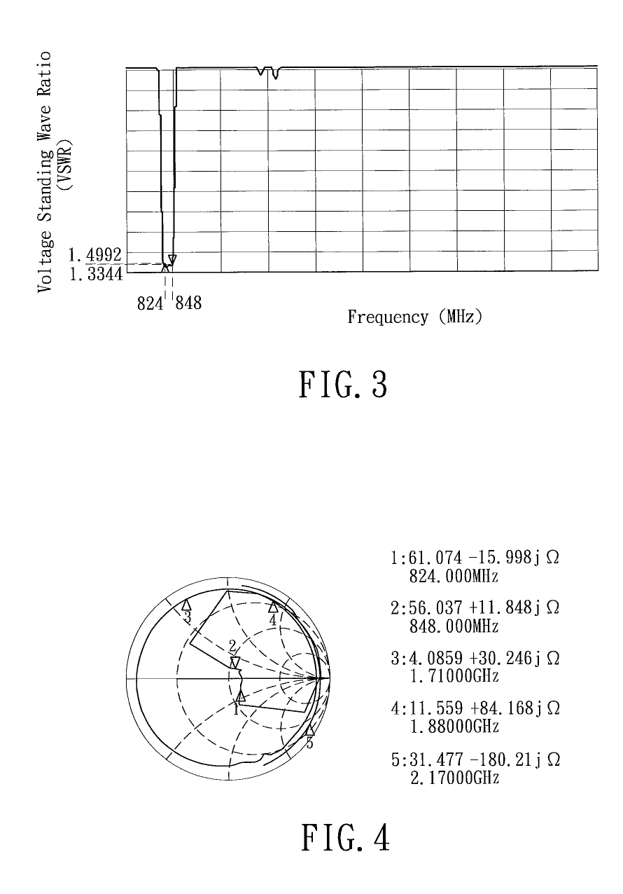

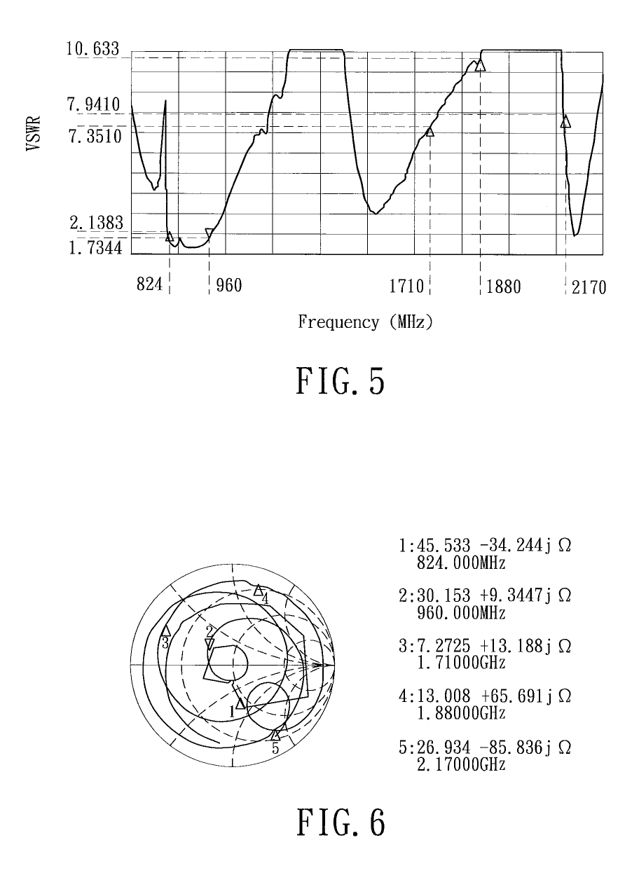

Referring to FIG. 1, the AC signal generates a voltage (V) at the input node of the electrical device 100, a current (I_{S}) to flow to the filter 2, and a current (I_{L}) to flow to the load 1. When the impedances of the load 1 and the filter 2 are respectively (Z_{L}) and (Z_{S}), the ratio of the currents (I_{L}) and (I_{S}) is I_{L}:I_{S}=V/Z_{L}:V/Z_{S}=Z_{S}:Z_{L}, i.e., inversely proportional to the ratio of the impedances. In the preferred embodiment, in a non-conducting frequency band, the filter 2 is accounted an open circuit for having high impedance such that the current flowing through the load 1 is not affected by the presence of the filter 2 as there is no current flowing through the filter 2 in the non-conducting frequency band (I_{S}=0). In a conducting frequency band, the filter 2 has substantially lower impedance than in the non-conducting frequency band. As such, the filter 2 divides the current of the AC signal within the conducting frequency band so that the current through the load 1 is reduced. The filter 2 of the preferred embodiment is a surface acoustic wave (SAW) filter with the conducting frequency band at the Tx band of the WCDMA Band V. Refer to FIGS. 3 and 4 respectively for the voltage standing wave ratio (VSWR) and Smith chart of the filter 2. The load 1 of the preferred embodiment is an antenna. As the current flowing through the load 1 is directly proportional to the specific absorption rate (SAR) of the load 1, SAR is used to show the magnitude of the current flowing through the load 1. Refer to FIGS. 5 and 6 respectively for the voltage standing wave ratio (VSWR) and Smith chart of the load 1. Table 1 below shows the total radiation power of the load 1 at different channels of the WCDMA Band (V) and the WCDMA Band VIII. Table 2 shows the SAR of the load 1 at different frequency channels of WCDMA Band (V) and WCDMA Band VIII.

TABLE 1
Length of a transmission line: 10.5 mm

| | | Total | | | Total |
|---|---|---|---|---|---|
| | | radiation | | | radiation |
| Frequency | | power | Frequency | | power |
| band | Channel | (dBm) | band | Channel | (dBm) |
| WCDMA Band | 4357 | 21.30 | WCDMA Band | 2937 | 22.71 |
| V | 4400 | 21.90 | VIII | 3013 | 22.46 |
| | 4458 | 23.76 | | 3088 | 22.08 |
| Average | | 22.45 | Average | | 22.42 |

TABLE 2
Length of a transmission line: 10.5 mm

| Frequency | | l g SAR | 10 g SAR |
|---|---|---|---|
| band | Channel | (W/kg) | (W/kg) |
| WCDMA | 4357 | 3.99 | 1.68 |
| Band V | 4400 | 5.20 | 2.65 |
| | 4458 | 2.88 | 1.48 |
| WCDMA | 2937 | 2.31 | 1.17 |
| Band VIII | 3013 | 2.99 | 1.51 |
| | 3088 | 2.54 | 1.27 |

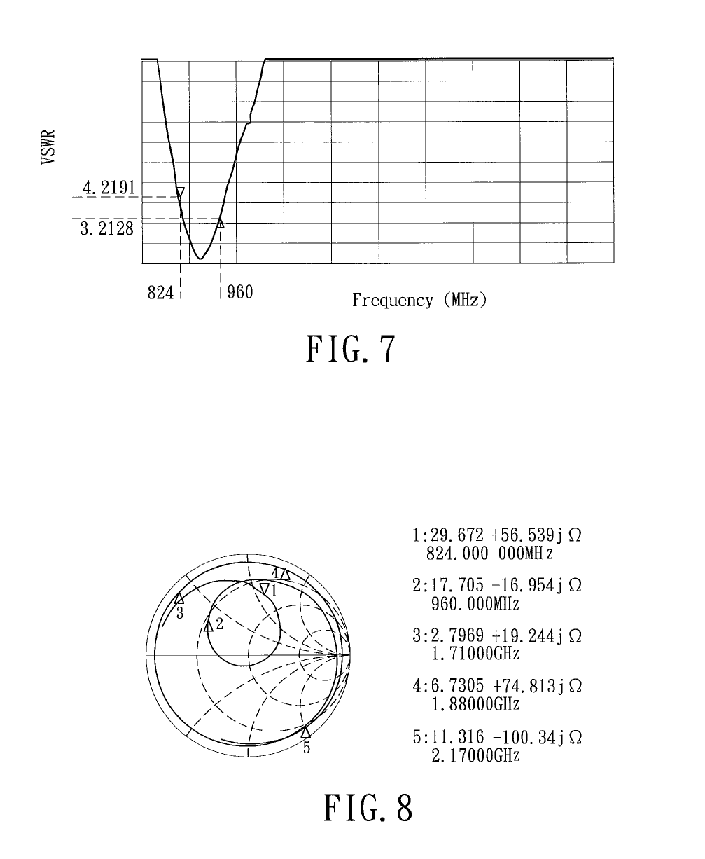

To better illustrate the effects of the preferred embodiment, an electrical device 100 having a similar structure to the electrical device 100 of the preferred embodiment but without the filter 2 is used as a control. FIGS. 7 and 8 are respectively the VSWR and the Smith chart of the load 1 of the control. Table 3 below shows the total radiation power of the load 1 of the control at different frequency channels of WCDMA Band (V) and WCDMA Band VIII. Table 4 shows the SAR of the load 1 of the control at different channels of the WCDMA Band (V) and the WCDMA Band VIII. Comparing Tables 2 and 4, the SAR of the load 1 of the preferred embodiment in the WCDMA Band (V) is distinctly lower than the load 1 of the control. The SAR of the load 1 of the preferred embodiment in the WCDMA Band VIII is similar to the load 1 of the control. In other words, the filter 2 effectively divided the current of the AC signal to reduce the current flowing into the load 1 in the preferred embodiment for the WCDMA Band V, which reduces the SAR of the load 1, while acting as an open circuit for the WCDMA Band VIII, without affecting the current flowing through the load 1 and thus the SAR of the load 1 in the WCDMA Band VIII.

TABLE 3
Length of a transmission line between the load 1 and the input
node: 10.5 mm

| | | Total | | | Total |
|---|---|---|---|---|---|
| | | radiation | | | radiation |
| Frequency | | power | Frequency | | power |
| band | Channel | (dBm) | band | Channel | (dBm) |
| WCDMA Band | 4357 | 14.58 | WCDMA | 2937 | 21.64 |
| V | 4400 | 16.09 | Band VIII | 3013 | 21.21 |
| | 4458 | 16.65 | | 3088 | 20.74 |
| Average | | 15.85 | Average | | 21.21 |

TABLE 4
Length of a transmission line between the load 1 and
the input node: 10.5 mm

| Frequency | | l g SAR | 10 g SAR |
|---|---|---|---|
| band | Channel | (W/kg) | (W/kg) |
| WCDMA | 4357 | 1.90 | 0.81 |
| Band V | 4400 | 1.70 | 0.73 |
| | 4458 | 1.56 | 0.68 |
| WCDMA | 2937 | 3.12 | 1.37 |
| Band VIII | 3013 | 2.85 | 1.26 |
| | 3088 | 2.39 | 1.09 |

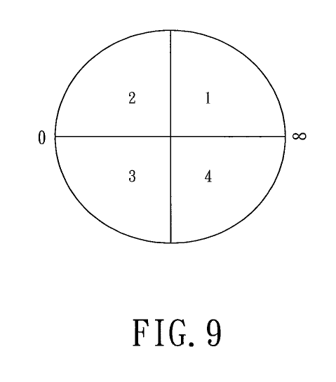

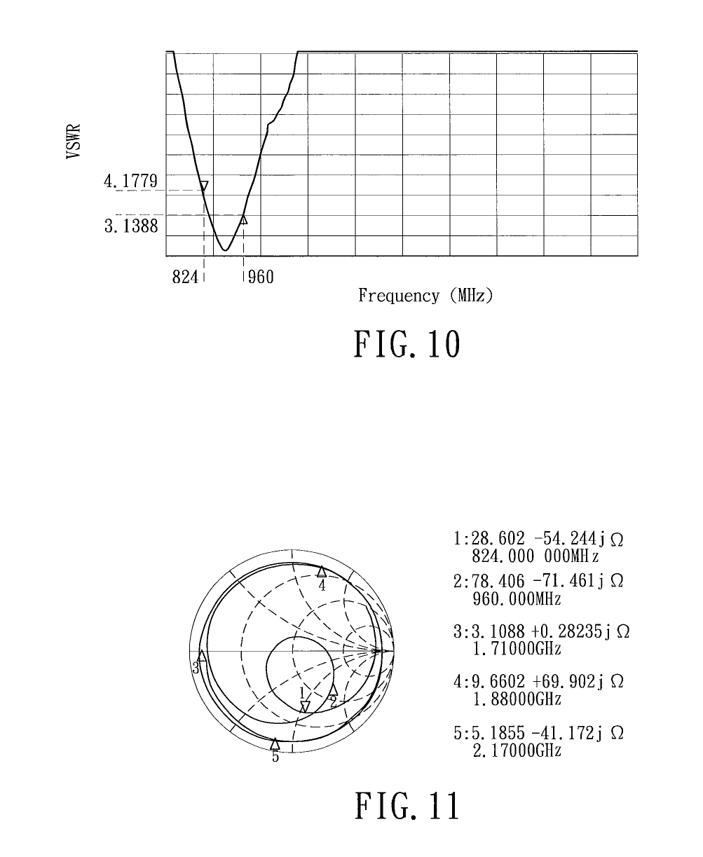

Apart from arranging the filter 2 parallel to the load 1 to adjust the current flowing through the load 1, changing the phase of the load 1 can also increase the impedance of the load 1 to reduce the current flowing through the load 1. FIG. 9 shows the different impedance regions of impedance of the Smith chart. Regions 1 and 4 are the high-impedance regions, and regions 2 and 3 are the low-impedance regions. The preferred embodiment adjusts the length of a transmission line that connects the load 1 and the filter 2 to adjust the impedance of the load 1 (See FIG. 1). FIGS. 10 and 11, and Table 5 and 6 respectively show the VSWR and the Smith chart, and the total radiation power and the SAR at different channels in the WCDMA Band V and the WCDMA Band VIII for the load 1 of the previously-mentioned control (without the filter 2) when the length of a transmission line between the load 1 and the input node is 16.5 mm. Please note that the length of the transmission line between the load 1 and the input node for the measurement shown in Tables 3 and 4, and for FIGS. 7 and 8 is 10.55 mm. Comparing FIGS. 8 and 11, the phase of the load 1 changed from the low impedance region (region 2) to the high impedance region (region 4) after the length between the load 1 and the input node is measured.

TABLE 5
Length of transmission line between the load 1 and the
input node: 16.5 mm

| | | Total | | | Total |
|---|---|---|---|---|---|
| | | radiation | | | radiation |
| Frequency | | power | Frequency | | power |
| band | Channel | (dBm) | band | Channel | (dBm) |
| WCDMA | 4357 | 21.09 | WCDMA | 2937 | 23.67 |
| Band V | 4400 | 21.36 | Band VIII | 3013 | 23.20 |
| | 4458 | 21.35 | | 3088 | 23.04 |
| Average | | 21.27 | Average | | 23.31 |

TABLE 6
Length of transmission line between the load 1 and
the input node: 16.5 mm

| Frequency | | l g SAR | 10 g SAR |
|---|---|---|---|
| band | Channel | (W/kg) | (W/kg) |
| WCDMA | 4357 | 6.64 | 2.60 |
| Band V | 4400 | 3.67 | 1.44 |
| | 4458 | 5.51 | 2.18 |
| WCDMA | 2937 | 3.10 | 1.24 |
| Band VIII | 3013 | 1.75 | 0.70 |
| | 3088 | 2.01 | 0.82 |

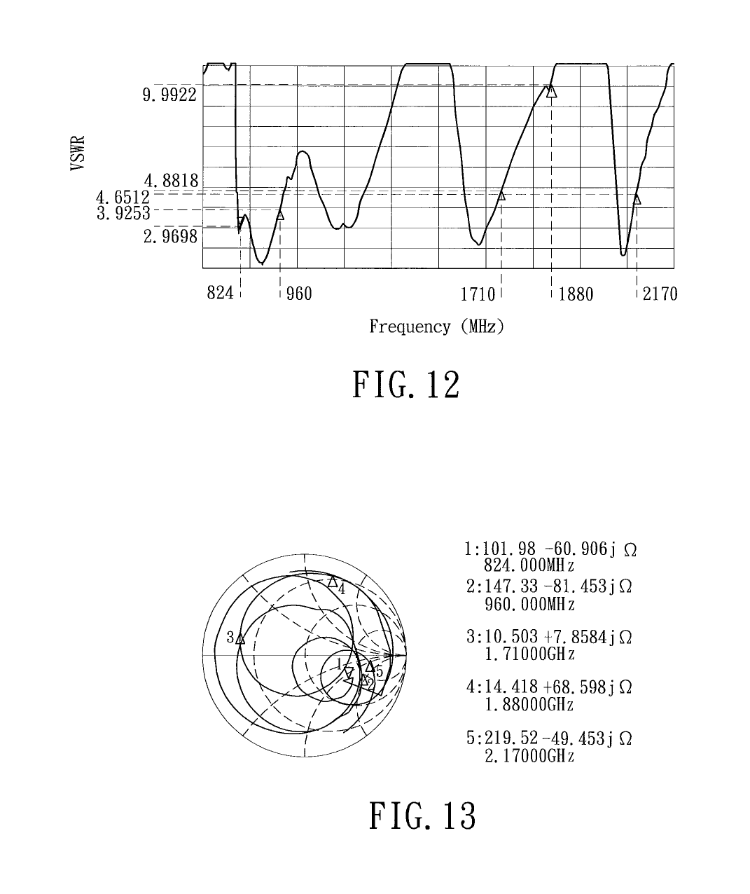

FIGS. 12 and 13, and Table 7 and 8 respectively show the VSWR and the Smith chart, and the total radiation power and the SAR at different channels in the WCDMA Band V and the WCDMA Band VIII for the load 1 of the preferred embodiment when the length of the transmission line 3 is 16.5 mm. Please note that the length of the transmission line between the load 1 and the input node for the measurement shown in Tables 3 and 4, and for FIGS. 7 and 8 is 10.55 mm. Comparing FIGS. 6 and 13, the phase of the load 1 changed from the low impedance region (regions 2, 3) to the high impedance region (region 4) after the length of the transmission line 3 is increased. Comparing Tables 2 and 8, the SAR for the load 1 in the WCDMA Band V is further reduced, proving that the current flowing through the load 1 is also further reduced, while that in the WCDMA Band VIII is unaffected. On top of that, comparing Tables 1 and 7, by increasing the impedance of the load 1 the total radiation power of the load 1 in WCDMA Band V is further increased.

TABLE 7
Length of transmission line: 16.5 mm

| | | Total | | | Total |
|---|---|---|---|---|---|
| | | radiation | | | radiation |
| Frequency | | power | Frequency | | power |
| band | Channel | (dBm) | band | Channel | (dBm) |
| WCDMA | 4357 | 19.39 | WCDMA | 2937 | 21.91 |
| Band V | 4400 | 18.65 | Band VIII | 3013 | 22.52 |
| | 4458 | 18.55 | | 3088 | 22.28 |
| Average | | 18.88 | Average | | 22.24 |

TABLE 8
Length of transmission line: 16.5 mm

| Frequency | | 1 g SAR | 10 g SAR |
|---|---|---|---|
| band | Channel | (W/kg) | (W/kg) |
| WCDMA | 4357 | 1.4 | 0.58 |
| Band V | 4400 | 1.04 | 0.55 |
| | 4458 | 1.31 | 0.69 |
| WCDMA | 2937 | 1.67 | 0.87 |
| Band VIII | 3013 | 1.22 | 0.64 |
| | 3088 | 1.31 | 0.68 |

In antenna designs, when it is found that the SAR of a certain regions of the frequency band exceeds the inspection limit, a filter 2 corresponding to the frequency band can be arranged parallel to the antenna as mentioned in the invention to reduce the SAR of that frequency band while not affecting antenna performance in other frequency bands.

Adding to that, the preferred embodiment uses an antenna and a SAW filter respectively as the load 1 and the filter 2, but the present invention is not limited to those components.

From the above, the present invention arranges a filter 2 parallel to the load 1 of an electrical device 100 so the filter 2 divides the current of an AC signal received by the electrical device 100 as the current is allowed to flow to the filter 2 in a conducting frequency band such that the flowing through the load 1 is reduced, while, in the non-conducting frequency band, the filter 2 acts as an open circuit such that the current continues to flow through the load 1 is unaffected. Also, by adjusting the length of a transmission line 3 electrically coupled between the load 1 and the filter 2, the impedance of the load 1 can be increased due to a change in phase to further reduce the current flowing through the load 1.

While the present invention has been described in connection with what is considered the most practical and preferred embodiment, it is understood that the invention is not limited to the disclosed embodiment but is intended to cover various arrangements included within the spirit and scope of the broadest interpretation so as to encompass all such modifications and equivalent arrangements.

What is claimed is:

1. A method for reducing a current through a load in an electrical device that further includes a filter connected in parallel to the load, said method comprising the steps of:
(a) configuring the electrical device to receive an alternating current (AC) signal; and
(b) configuring the filter to determine the current flowing through the load according to a frequency of the AC signal.

2. The method as claimed in claim 1, wherein an impedance of the filter in a conducting frequency band is lower than an impedance of the filter in a non-conducting frequency band, and in step (b), the filter divides the current of the AC signal within the conducting frequency band so that the load current flowing through the load is reduced.

3. The method as claimed in claim 2, wherein in step (b), a transmission line of the electrical device electrically coupled between the load and the filter moves a phase of the load to a high impedance region of a Smith Chart to further reduce the current flowing through the load.

4. The method as claimed in claim 3, wherein a length of the transmission line is relative to the impedance region of the Smith Chart within which the phase of the load falls.

5. The method as claimed in claim 1, wherein in step (b), the filter is a surface acoustic wave filter.

6. The method as claimed in claim 1, wherein in step (b), the load is an antenna.

7. An electrical device for receiving an AC signal, comprising:
a load; and
a filter connected in parallel to said load, said filter determining a current flowing through said load according to a frequency of the AC signal.

8. The electrical device as claimed in claim 7, wherein an impedance of said filter in a conducting frequency band is lower than an impedance of said filter in a non-conducting frequency band, said filter dividing the current of the AC signal within the conducting frequency band so that the current through said load is reduced.

9. The electrical device as claimed in claim 8, further comprising a transmission line electrically coupled between said load and said filter, said transmission line moving a phase of said load to a high impedance region of a Smith Chart to further reduce the current through said load.

10. The electrical device as claimed in claim 9, wherein a length of said transmission line is relative to the impedance region of the Smith Chart within which the phase of said load falls.

11. The electrical device as claimed in claim 7, wherein said filter is an acoustic wave filter.

12. The electrical device as claimed in claim 7, wherein said load is an antenna.
